(19) United States
(12) Patent Application Publication
(10) Pub. No.: US 2025/0018819 A1
(43) Pub. Date: Jan. 16, 2025

(54) CHARGING AND DISCHARGING SYSTEM AND METHOD OF CONTROLLING CHARGING AND DISCHARGING SYSTEM

(71) Applicant: GS Yuasa International Ltd., Kyoto-shi, Kyoto (JP)

(72) Inventor: Hiroaki ENDO, Kyoto-shi, Kyoto (JP)

(21) Appl. No.: 18/715,577

(22) PCT Filed: Nov. 24, 2022
(86) PCT No.: PCT/JP2022/043268

§ 371 Date: May 31, 2024

(30) Foreign Application Priority Data
Dec. 2, 2021 (JP) 2021-196296

(51) Int. Cl. B60L 53/65; H02J 7/00

(52) U.S. Cl. CPC B60L 53/65; H02J 7/007182

(57) ABSTRACT

A charging and discharging system 10 including a charging and discharging device 100 to which a vehicle energy storage apparatus 40 of a vehicle 30 is connected and which supplies electric power to an electric power load 20 includes a first charging and discharging device 100a, which is the charging and discharging device 100 to which a first vehicle energy storage apparatus 40a being the vehicle energy storage apparatus 40 is connected and which is electrically connected to a second charging and discharging device 100b being another charging and discharging device 100 to which a second vehicle energy storage apparatus 40b being another vehicle energy storage apparatus 40 is connected. The first charging and discharging device 100a includes a control section 120 controlling the first voltage output from the first charging and discharging device 100a and the first phase of the first voltage in such a way as to match the second voltage output from the second charging and discharging device 100b and the second phase of the second voltage.

### CROSS REFERENCE TO RELATED APPLICATIONS

This application is a National Stage Application, filed under 35 U.S.C. § 371, of International Application No. PCT/JP2022/043268, filed Nov. 24, 2022, which international application claims priority to and the benefit of Japanese Application No. 2021-196296, filed Dec. 2, 2021; the contents of both of which are hereby incorporated by reference in their entirety.

### BACKGROUND

### Technical Field

The present invention relates to a charging and discharging system to which a vehicle energy storage apparatus that is an energy storage apparatus of a vehicle is connected and which supplies electric power to an electric power load, and a method of controlling the charging and discharging system.

### Description of Related Art

Conventionally, there is known a charging and discharging system that includes a charging and discharging device to which a vehicle energy storage apparatus is connected and which supplies electric power to an electric power load. Japanese Unexamined Patent Application Publication No. 2014-212659 discloses a power supply system (a charging and discharging system in the present specification) in which electric power is supplied to an in-facility electric power system from a charging and discharging station (a charging and discharging device in the present specification) to which a storage battery (a vehicle energy storage apparatus in the present specification) of an electric vehicle is connected.

### BRIEF SUMMARY

In the conventional charging and discharging system as disclosed in Japanese Unexamined Patent Application Publication No. 2014-212659, a plurality of charging and discharging devices are arranged, but when an electric power load is connected to each charging and discharging device, there is a problem that electric power cannot be supplied from one charging and discharging device to the electric power load connected to another charging and discharging device. Specifically, when a first electric power load is connected to a first charging and discharging device and a second electric power load is connected to a second charging and discharging device, electric power can be supplied from the second charging and discharging device to the second electric power load if a vehicle energy storage apparatus is connected to the second charging and discharging device. However, when the vehicle energy storage apparatus is not connected to the second charging and discharging device and the vehicle energy storage apparatus is connected to the first charging and discharging device, the first charging and discharging device can supply electric power to the first electric power load, but cannot supply electric power to the second electric power load.

One aspect of the present invention provides a charging and discharging system capable of supplying electric power from one charging and discharging device to an electric power load connected to another charging and discharging device, among the charging and discharging devices to which a vehicle energy storage apparatus is connected, and a method of controlling the charging and discharging system.

A charging and discharging system according to one aspect of the present invention includes a charging and discharging device to which a vehicle energy storage apparatus that is an energy storage apparatus of a vehicle is connected, and the charging and discharging device supplies electric power to an electric power load. The charging and discharging system includes a first charging and discharging device, which is the charging and discharging device to which a first vehicle energy storage apparatus that is the vehicle energy storage apparatus is connected and the first charging and discharging device is electrically connected to a second charging and discharging device that is another charging and discharging device to which a second vehicle energy storage apparatus that is another vehicle energy storage apparatus is connected. The first charging and discharging device includes a control section that controls a first voltage, which is a voltage being output from the first charging and discharging device, and a first phase, which is a phase of the first voltage, in such a way as to match a second voltage, which is a voltage being output from the second charging and discharging device, and a second phase, which is a phase of the second voltage.

The present invention can be achieved not only as such a charging and discharging system but also as a method of controlling the charging and discharging system. The present invention can also be achieved as a program for causing a computer to execute processing included in the method of controlling the charging and discharging system, and can also be achieved as a computer-readable recording medium such as a CD-ROM on which the program is recorded. The program can be distributed via the recording medium and a transmission medium such as the Internet. The present invention can also be achieved as an integrated circuit including a processing section included in the charging and discharging system.

According to the charging and discharging system in one aspect of the present invention, electric power can be supplied from one charging and discharging device to an electric power load connected to another charging and discharging device, among the charging and discharging devices to which the vehicle energy storage apparatus is connected.

### BRIEF DESCRIPTION OF THE FIGURES

FIG. 1 is a perspective view illustrating a configuration of a charging and discharging system according to an embodiment.

FIG. 2 is a block diagram illustrating a configuration of the charging and discharging system.

FIG. 3 is a block diagram illustrating a functional configuration of a charging and discharging device.

FIG. 4 is a flowchart illustrating processing to be performed by the charging and discharging system.

FIG. 5 is a flowchart illustrating processing in which a control section controls a first voltage and a first phase of a first charging and discharging device.

FIG. 6 is a diagram for explaining processing in which the control section controls the first voltage and the first phase of the first charging and discharging device (when the first charging and discharging device is a slave machine).

FIG. 7 is a diagram for explaining processing in which the control section controls the first voltage and the first phase of the first charging and discharging device (when the first charging and discharging device is a master machine).

FIG. 8 is a flowchart illustrating processing in which the control section controls the first voltage and the first phase of the first charging and discharging device (when the master machine is changed).

FIG. 9 is a diagram for explaining processing in which the control section controls the first voltage and the first phase of the first charging and discharging device (when the master machine is changed).

FIG. 10 is a flowchart illustrating processing in which the control section controls a current of the first charging and discharging device.

FIG. 11 is a block diagram illustrating a configuration of a conventional charging and discharging system.

### DETAILED DESCRIPTION OF VARIOUS EMBODIMENTS

A charging and discharging system according to one aspect of the present invention includes a charging and discharging device to which a vehicle energy storage apparatus that is an energy storage apparatus of a vehicle is connected, and the charging and discharging device supplies electric power to an electric power load. The charging and discharging system includes a first charging and discharging device, which is the charging and discharging device to which a first vehicle energy storage apparatus that is the vehicle energy storage apparatus is connected and the charging and discharging device is electrically connected to a second charging and discharging device that is another charging and discharging device to which a second vehicle energy storage apparatus that is another vehicle energy storage apparatus is connected. The first charging and discharging device includes a control section that controls a first voltage, which is a voltage being output from the first charging and discharging device, and a first phase, which is a phase of the first voltage, in such a way as to match a second voltage, which is a voltage being output from the second charging and discharging device, and a second phase, which is a phase of the second voltage.

As in the above-described configuration, by matching the first voltage being output from the first charging and discharging device and the first phase with the second voltage being output from the second charging and discharging device and the second phase, the first charging and discharging device and the second charging and discharging device can be connected in parallel. As a result, electric power can be supplied from the first charging and discharging device to an electric power load connected to the second charging and discharging device, and electric power can be supplied from the second charging and discharging device to an electric power load connected to the first charging and discharging device. In short, the charging and discharging system has a self-sustaining parallel function. Therefore, according to the charging and discharging system, electric power can be supplied from one charging and discharging device to an electric power load connected to another charging and discharging device, among the charging and discharging devices to which the vehicle energy storage apparatus is connected. When a vehicle is parked in one of a plurality of parking spaces, electric power can be supplied from the vehicle energy storage apparatus not only to an electric power load connected to a charging and discharging device provided in the parking space but also to an electric power load connected to a charging and discharging device provided in another parking space. Power can be supplied from the vehicle energy storage apparatus to the electric power load without a driver of the vehicle having to worry about which parking space to park in.

In a case where the first vehicle energy storage apparatus is connected to the first charging and discharging device, if the second vehicle energy storage apparatus is connected to the second charging and discharging device, the control section may determine that the second charging and discharging device is a master machine and the first charging and discharging device is a slave machine, and may control the first voltage and the first phase in such a way as to match the second voltage and the second phase of the second charging and discharging device.

According to the above-described configuration, the charging and discharging system sets the second charging and discharging device to which the vehicle energy storage apparatus is connected first as a master machine, sets the first charging and discharging device to which the vehicle energy storage apparatus is connected later as a slave machine, and controls the first voltage and the first phase of the slave machine in such a way as to match the second voltage and the second phase of the master machine. The charging and discharging system sets the master machine and the slave machine in this way, and connects the master machine and the slave machine in parallel. Thus, electric power can be supplied from the slave machine to an electric power load connected to the master machine, and electric power can be supplied from the master machine to an electric power load connected to the slave machine.

When the second vehicle energy storage apparatus is connected to each of the plurality of second charging and discharging devices, the control section may acquire master information indicating which second charging and discharging device is a master machine, and may control the first voltage and the first phase in such a way as to match the second voltage and the second phase of the second charging and discharging device being the master machine indicated by the master information.

The charging and discharging system can supply electric power from the slave machine to the electric power load connected to the master machine and can supply electric power from the master machine to the electric power load connected to the slave machine by setting the master machine from the master information and connecting the master machine and the slave machine in parallel.

In a case where the first vehicle energy storage apparatus is connected to the first charging and discharging device, if the second vehicle energy storage apparatus is not connected to the second charging and discharging device, the control section may determine that the first charging and discharging device is a master machine, and may control the first voltage and the first phase in such a way as to match a predetermined voltage and phase.

According to the above-described configuration, the charging and discharging system sets the first charging and discharging device to which the vehicle energy storage apparatus is first connected as the master machine, and controls the first voltage and the first phase of the master machine in such a way as to match a predetermined voltage and phase. In other words, when there is no other charging and discharging device for which the voltage and phase are to be matched, the control section determines the control section itself to be a master machine, and controls the first voltage and first phase in such a way as to match a predetermined voltage and phase. Thus, the charging and discharging system can set the voltage and phase of the slave machine to which the vehicle energy storage apparatus is connected later, based on the voltage and the phase of the master machine, and can connect the master machine and the slave machine in parallel.

When it is determined that the master machine has been changed, the control section may control the first voltage and the first phase in such a way as to match the second voltage and the second phase of the second charging and discharging device being the changed master machine.

According to the above-described configuration, even when the master machine has been changed, the charging and discharging system can connect the changed master machine and the slave machine in parallel by controlling the first voltage and the first phase of the slave machine in such a way as to match the second voltage and the second phase of the changed master machine.

The control section may determine that the master machine has been changed when a value indicating a remaining capacity of the second vehicle energy storage apparatus connected to the second charging and discharging device being the master machine becomes equal to or less than a predetermined threshold value or when the second vehicle energy storage apparatus is disconnected from the second charging and discharging device being the master machine.

When the value indicating the remaining capacity of the second vehicle energy storage apparatus connected to the second charging and discharging device being the master machine becomes equal to or less than a predetermined threshold value, or when the second vehicle energy storage apparatus is disconnected from the second charging and discharging device being the master machine, electric power cannot be supplied from the second charging and discharging device. Therefore, it is necessary to change the master machine. With the above-described configuration, the charging and discharging system can connect the changed master machine and the slave machine in parallel by controlling the first voltage and the first phase of the slave machine in such a way as to match the second voltage and the second phase of the changed master machine.

The control section may determine a magnitude of a current being output from the first charging and discharging device according to a remaining capacity of the first vehicle energy storage apparatus connected to the first charging and discharging device.

When the remaining capacity of the first vehicle energy storage apparatus connected to the first charging and discharging device changes, electric power that can be discharged from the first vehicle energy storage apparatus changes, and electric power that can be supplied from the first charging and discharging device to the electric power load changes in some cases. The charging and discharging system determines the magnitude of the current being output from the first charging and discharging device according to the remaining capacity of the first vehicle energy storage apparatus connected to the first charging and discharging device, and thus can supply electric power having a magnitude corresponding to the remaining capacity of the first vehicle energy storage apparatus from the first charging and discharging device to the electric power load.

The control section may compare the remaining capacity of the first vehicle energy storage apparatus with the remaining capacity of the second vehicle energy storage apparatus connected to the second charging and discharging device, and may adjust a current being output from a charging and discharging device connected to a vehicle energy storage apparatus having a larger remaining capacity to be larger than a current being output from a charging and discharging device connected to a vehicle energy storage apparatus having a smaller remaining capacity.

As the remaining capacity of the vehicle energy storage apparatus connected to the charging and discharging device increases, a larger amount of electric power can be discharged from the vehicle energy storage apparatus, and thus a larger amount of electric power can be supplied from the charging and discharging device to the electric power load. The charging and discharging system compares the remaining capacities of the first vehicle energy storage apparatus and the second vehicle energy storage apparatus, and increases the current being output from the charging and discharging device connected to the vehicle energy storage apparatus having the larger remaining capacity, thereby enabling to supply electric power from the charging and discharging device to the electric power load in a well-balanced manner.

The charging and discharging system according to one aspect of the present invention is a charging and discharging system including a charging and discharging device to which a vehicle energy storage apparatus that is an energy storage apparatus of a vehicle is connected and which supplies electric power to an electric power load. The charging and discharging system includes a first charging and discharging device that is the charging and discharging device to which a first vehicle energy storage apparatus that is the vehicle energy storage apparatus is connected, and the first charging and discharging device may include a control section that performs voltage-type voltage control.

As in the above-described configuration, the first charging and discharging device performs the voltage-type voltage control, and thus the first charging and discharging device and the second charging and discharging device that is another charging and discharging device can be connected in parallel. In short, the charging and discharging system has a self-sustaining parallel function, and can supply electric power from the first charging and discharging device to the electric power load connected to the second charging and discharging device, and can supply electric power from the second charging and discharging device to the electric power load connected to the first charging and discharging device. Therefore, according to the charging and discharging system, electric power can be supplied from one charging and discharging device to an electric power load connected to another charging and discharging device, among the charging and discharging devices to which the vehicle energy storage apparatus is connected.

The method of controlling the charging and discharging system according to one aspect of the present invention is a method of controlling the charging and discharging system including a charging and discharging device to which a vehicle energy storage apparatus that is an energy storage apparatus of a vehicle is connected and which supplies electric power to an electric power load. In the method, a first charging and discharging device controls a first voltage that is a voltage being output from the first charging and discharging device and a first phase that is a phase of the first voltage in such a way as to match a second voltage that is a voltage being output from the second charging and discharging device and a second phase that is a phase of the second voltage, the first charging and discharging device being the charging and discharging device to which a first vehicle energy storage apparatus that is the vehicle energy storage apparatus is connected and being electrically connected to a second charging and discharging device that is another charging and discharging device to which a second vehicle energy storage apparatus that is another vehicle energy storage apparatus is connected.

With the above-described configuration, electric power can be supplied from the first charging and discharging device to the electric power load connected to the second charging and discharging device, and electric power can be supplied from the second charging and discharging device to the electric power load connected to the first charging and discharging device. Therefore, according to the method of controlling the charging and discharging system, among the charging and discharging devices to which the vehicle energy storage apparatus is connected, electric power can be supplied from one charging and discharging device to an electric power load connected to another charging and discharging device.

Hereinafter, with reference to the drawings, explanation will be made on the charging and discharging system, the method of controlling the charging and discharging system, and the like according to an embodiment (including modification) of the present invention. Each of the embodiments to be described below illustrates a comprehensive or specific example. A numerical value, a component, an arrangement position and connection configuration of the components, control processing, an order of the control processing, and the like, which will be described in the following embodiment, are merely examples, and are not intended to limit the present invention. Each of the drawings is a schematic view and is not necessarily strictly illustrated. In the drawings, the same or similar components are denoted by the same reference numerals.

### EMBODIMENT

### [1 Explanation of Charging and Discharging System 10]

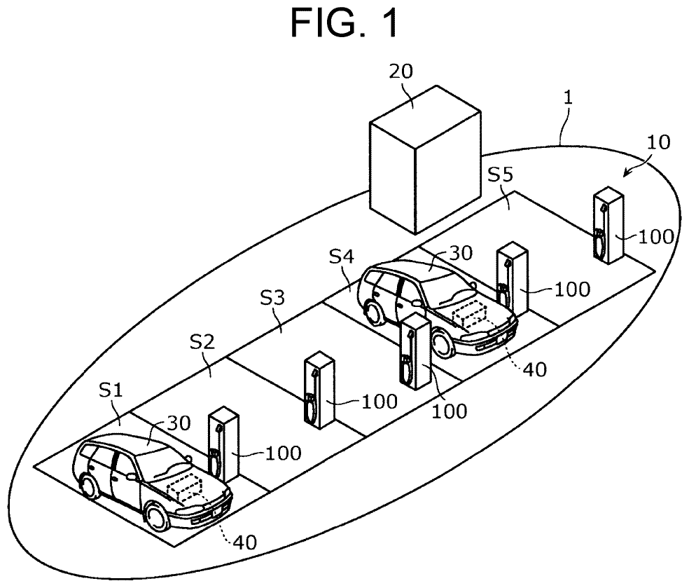

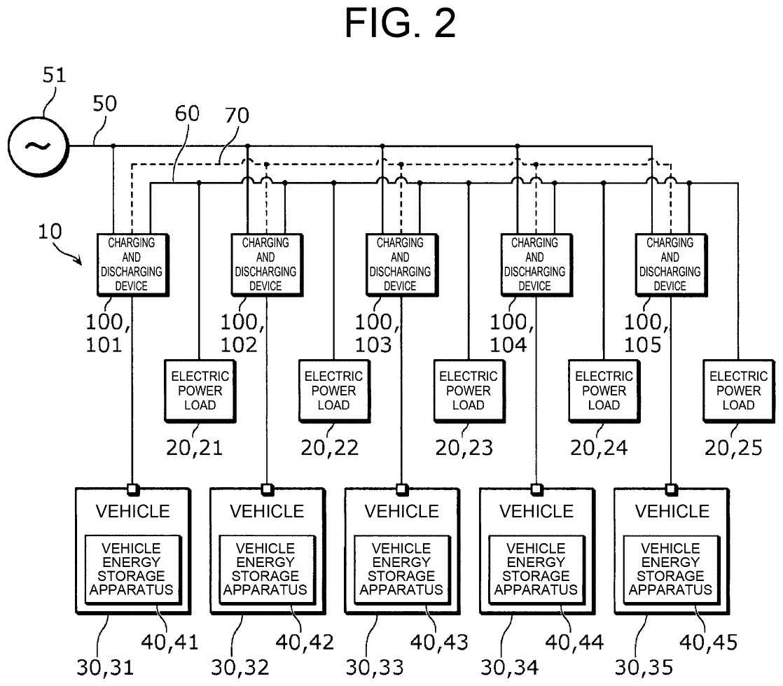

First, a charging and discharging system 10 will be explained. FIG. 1 is a perspective view illustrating a configuration of the charging and discharging system 10 according to an embodiment. FIG. 1 is an image diagram illustrating the charging and discharging system 10 including a charging and discharging device 100 to which a vehicle energy storage apparatus 40 of a vehicle 30 is connected and which supplies electric power to an electric power load 20. The electric power load 20 may be installed indoors or may be installed in a remote place. FIG. 2 is a block diagram illustrating a configuration of the charging and discharging system 10 according to the present embodiment. FIG. 2 illustrates a state in which the vehicle 30 (vehicle energy storage device 40) is connected to all of the charging and discharging devices 100 illustrated in FIG. 1.

As illustrated in FIGS. 1 and 2, the charging and discharging system 10 is a system that performs charging and discharging with the vehicle energy storage apparatus 40 of the vehicle 30 in a predetermined supply area 1 (see FIG. 1) to which electric power is supplied from an electric power system 50 (see FIG. 2), and that supplies electric power to the electric power load 20 in the supply area 1. The charging and discharging system 10 includes a plurality of charging and discharging devices 100 to which the vehicle 30 (vehicle energy storage apparatus 40) is connected. Although five of charging and discharging devices 100 are illustrated in FIGS. 1 and 2, the number of charging and discharging devices 100 included in the charging and discharging system 10 is not particularly limited.

As illustrated in FIG. 1, the charging and discharging system 10 may be arranged in a centralized charging and discharging station in which parking spaces S1 to S5 are arranged adjacent to each other, or may be arranged in a distributed charging and discharging station (not illustrated) in which parking spaces are arranged in a distributed manner (arranged on different floors of a building or the like). In FIG. 1, the charging and discharging device 100 is arranged in each of the parking spaces (S1, S2, . . . ), but the present invention is not limited to this form, and one charging and discharging device 100 may be arranged in a plurality of parking spaces, or a plurality of charging and discharging devices 100 may be arranged in one parking space. A plurality of vehicles 30 (a plurality of vehicle energy storage apparatuses 40) may be connected to one charging and discharging device 100. The charging and discharging station in which the charging and discharging system 10 is arranged may be provided in a public place such as a public parking lot, or may be provided in the premises of a company or an individual.

As illustrated in FIG. 2, the charging and discharging device 100 is connected to the electric power system 50, the vehicle energy storage apparatus 40, and the electric power load 20, and exchanges electric power with them. In short, the charging and discharging device 100 receives electric power from the electric power system 50 and the vehicle energy storage apparatus 40, and supplies electric power to the electric power system 50, the vehicle energy storage apparatus 40, and the electric power load 20. Specifically, the charging and discharging device 100 is a charging and discharging stand that is connected to the vehicle energy storage apparatus 40, which is an energy storage apparatus of the vehicle 30, and performs charging and discharging with the vehicle energy storage apparatus 40. The charging and discharging device 100 supplies (charges) electric power from the electric power system 50 to the vehicle energy storage apparatus 40 or supplies the electric power to the electric power load 20 in a normal state or the like, and discharges the vehicle energy storage apparatus 40 and supplies electric power to the electric power load 20 in an emergency or the like.

The electric power system 50 is, for example, a commercial power system owned by an electric power company, and AC power generated by a system power supply 51 such as a thermal power plant flows through the electric power system 50. The electric power system 50 supplies the AC power to the charging and discharging device 100. The electric power system 50 is not limited to a commercial power system, and may be an electric power system that is provided outside the charging and discharging system 10 and supplies electric power to the charging and discharging system 10, or may be an electric power system installed in an isolated island or a predetermined area that is not connected to a commercial power system.

The vehicle 30 is an automobile (a mobile body) such as an electric vehicle (EV) or a plug-in hybrid electric vehicle (PHEV). The vehicle energy storage apparatus 40, which is an energy storage apparatus (a power supply apparatus or a battery) mounted on the vehicle 30, supplies electric power to the vehicle 30 and drives the vehicle 30. The vehicle energy storage apparatus 40 is charged with electric power and discharges electric power via the charging and discharging device 100. Specifically, the vehicle energy storage apparatus 40 includes a plurality of energy storage elements connected in series and/or in parallel. The energy storage element is a secondary battery (unit cell) capable of charging and discharging electricity, and is, for example, a nonaqueous electrolyte secondary battery such as a lithium ion secondary battery. The energy storage element is not limited to the nonaqueous electrolyte secondary battery, and may be a secondary battery other than the nonaqueous electrolyte secondary battery, a capacitor, a primary battery, a battery using a solid electrolyte, or the like.

In the present embodiment, the charging and discharging system 10 includes five charging and discharging devices 100 (101 to 105), and the five charging and discharging devices 100 (101 to 105) are configured to be connectable to the vehicle energy storage apparatuses 40 (41 to 45) of the vehicles 30 (31 to 35), respectively. In short, the vehicle 30 (vehicle energy storage apparatus 40) connected to the charging and discharging device 101 is referred to as a vehicle 31 (vehicle energy storage apparatus 41), and the vehicle 30 (vehicle energy storage apparatus 40) connected to the charging and discharging device 102 is referred to as a vehicle 32 (vehicle energy storage apparatus 42). The same applies to the charging and discharging devices 103 to 105.

The electric power load 20 is a power load consumed in the supply area 1, and includes a specific load used even in an emergency such as a power failure, a general load used in a normal state, and the like. Specifically, the electric power load 20 includes a power load used for an elevator, an air conditioner for business use, or the like in a facility such as an office, an electric lamp load used for lighting, an electric outlet, or the like in a facility such as an office, a load for operating a household electrical appliance or a mechanical equipment in a factory, and the like.

In the present embodiment, the five charging and discharging devices 100 (101 to 105) are connected to each other via electric wires 60, and five electric power loads 20 (21 to 25) are connected to the five charging and discharging devices 100 (101 to 105), respectively, via the electric wires 60. The electric power loads 21 to 25 may be different electric power loads, for example, the electric power load 21 may be a three-phase load of a power system used for air conditioning or the like, and the electric power load 22 may be a single-phase load of an electric lamp system used for lighting or the like. The electric power load 21 is connected to the charging and discharging device 101, and the charging and discharging device 101 can be used as a backup of the electric power load 21 at the time of power failure. The electric power load 22 is connected to the charging and discharging device 102, and the charging and discharging device 102 can be used as a backup of the electric power load 22 at the time of power failure. The same applies to the charging and discharging devices 103 to 105.

Since the charging and discharging devices 101 to 105 are electrically connected to each other via the electric wire 60, any charging and discharging device 100 among the charging and discharging devices 101 to 105 can supply electric power to any electric power load 20 among the electric power loads 21 to 25. In short, electric power can also be supplied from the charging and discharging device 101 to the electric power loads 22 to 25, and electric power can also be supplied from the charging and discharging device 102 to the electric power loads 21 and 23 to 25. The same applies to the charging and discharging devices 103 to 105. As described above, the electric power system 50 is an interconnected line for supplying system electric power, whereas the electric wire 60 is a self-sustaining line for self-sustaining parallel operation. Further, the charging and discharging devices 101 to 105 are connected to each other via a communication line 70, and can communicate with each other by RS485 communication or the like. Thus, the charging and discharging devices 101 to 105 are configured to be able to exchange information (address information and the like) with each other. Hereinafter, configurations and functions of the charging and discharging devices 100 (101 to 105) will be explained in detail.

### [2 Explanation of Charging and Discharging Device 100]

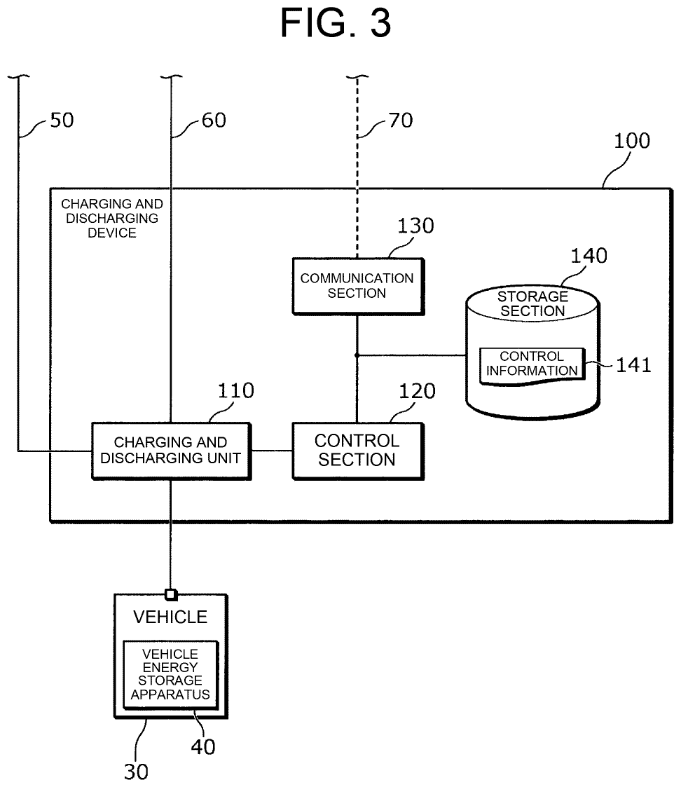

FIG. 3 is a block diagram illustrating a functional configuration of the charging and discharging device 100 according to the present embodiment. Since all of five charging and discharging devices 100 (101 to 105) included in the charging and discharging system 10 have the same configuration, one charging and discharging device 100 will be explained below.

As illustrated in FIG. 3, the charging and discharging device 100 includes a charging and discharging unit 110, a control section 120, a communication section 130, and a storage section 140. In addition to the above-described configuration, the charging and discharging device 100 may include an input section (operation section) that receives an input from a user, a display section (display screen) such as a liquid crystal display that displays various kinds of information, and the like. The charging and discharging device 100 may include a touch panel having functions of an input section and a display section.

The charging and discharging unit 110 is a bidirectional conversion circuit that selectively performs forward conversion (conversion) for converting AC power into DC power and reverse conversion (inversion) for converting DC power into AC power. The charging and discharging unit 110 converts AC power from the electric power system 50 into DC power, supplies the DC power to the vehicle energy storage apparatus 40, and then charges the vehicle energy storage apparatus 40. The charging and discharging unit 110 converts DC power discharged from the vehicle energy storage apparatus 40 into AC power (single-phase AC power or three-phase AC power), and supplies the AC power to the electric power load 20 via the electric wire 60.

The control section 120 controls the charging and discharging unit 110 by giving a command to the charging and discharging unit 110. The control section 120 has a function of controlling a voltage of the electric power being output from the charging and discharging unit 110, a phase of the voltage, a current, and the like. The control section 120 also has a function of determining which charging and discharging device 100 included in the charging and discharging system 10 is a master machine, how many charging and discharging devices 100 are included in the charging and discharging system 10, and the like. The control section 120 has a function of acquiring information indicating whether the vehicle energy storage apparatus 40 is connected to each of the charging and discharging devices 100 included in the charging and discharging system 10 and various information, such as State Of Charge (SOC) of the vehicle energy storage apparatus 40 when connected. The control section 120 communicates with another charging and discharging device 100 by transmitting information to the another charging and discharging device 100 or acquiring information from the another charging and discharging device 100 via the communication section 130. Details of processing performed by the control section 120 (processing performed by the charging and discharging system 10 and a method of controlling the charging and discharging system 10) will be described below.

The communication section 130 is a communication board such as a network interface card (NIC), which can communicate with another communication section 130 included in another charging and discharging device 100 via the communication line 70. The communication section 130 acquires information from the control section 120, transmits the acquired information to another communication section 130, and acquires information regarding the another charging and discharging device 100 from the another communication section 130. The communication section 130 may communicate with another communication section 130 included in another charging and discharging device 100 by wireless communication without using the communication line 70.

The storage section 140 is a memory that stores data necessary for the control section 120 to perform control, and the like, such as data acquired by the communication section 130 and data acquired or generated by the control section 120. The storage section 140 stores control information 141. In the control information 141, data necessary for the control section 120 to perform control is written. Specifically, in the control information 141, there are stored information (master information) indicating which of the charging and discharging devices 100 included in the charging and discharging system 10 is the master machine, and information indicating how many charging and discharging devices 100 are included in the charging and discharging system 10. In the control information 141, there are also stored a predetermined voltage and a phase of the voltage (a standard voltage and a phase thereof) which are set when the own charging and discharging device 100 is a master machine, and a voltage of the master machine and a phase of the voltage when the own charging and discharging device 100 is a slave machine. In the control information 141, there are also stored information indicating whether the vehicle energy storage apparatus 40 is connected to each charging and discharging device 100 included in the charging and discharging system 10, and various information, such as the SOC of the vehicle energy storage apparatus 40 when connected.

### [3 Explanation of Processing Flow of Charging and Discharging System 10]

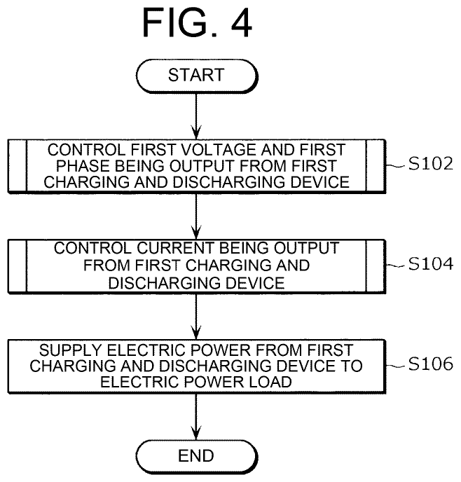

Next, processing to be performed by the charging and discharging system 10 (a method of controlling the charging and discharging system 10) will be explained. Specifically, various processing to be performed by the control section 120 included in the charging and discharging device 100 of the charging and discharging system 10 will be explained in detail. FIG. 4 is a flowchart illustrating processing performed by the charging and discharging system 10 (the control section 120 included in the charging and discharging device 100) according to the present embodiment.

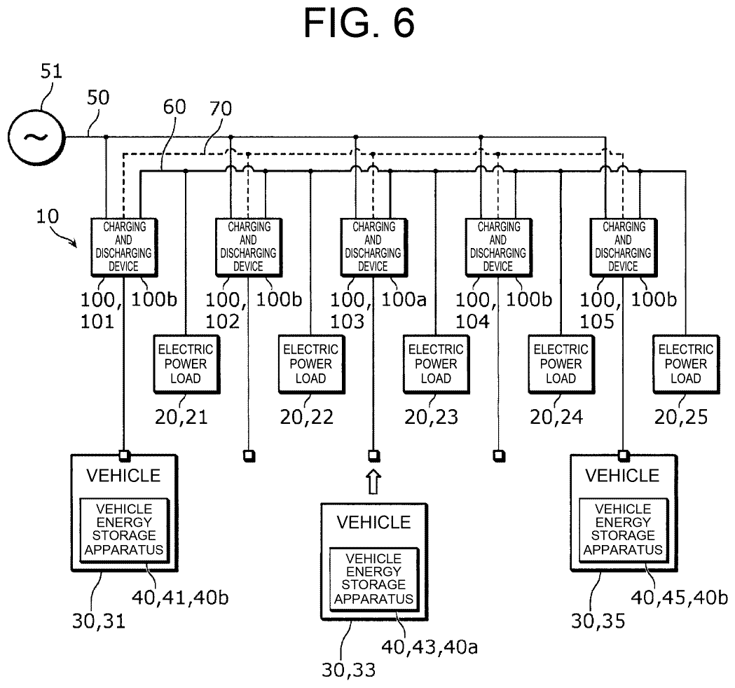

In the following explanation, the own charging and discharging device 100 controlled by the target control section 120 (the charging and discharging device 100 having the target control section 120) is also referred to as a first charging and discharging device 100a, and another charging and discharging devices 100 is also referred to as a second charging and discharging device 100b (see FIG. 6 and the like for reference numerals, 100a and 100b). In short, the first charging and discharging device 100a is electrically connected to the second charging and discharging device 100b, which is another charging and discharging device 100, via the electric wire 60. A voltage of electric power being output from the first charging and discharging device 100a is also referred to as a first voltage, a phase of the first voltage is also referred to as a first phase. A voltage of electric power being output from the second charging and discharging device 100b is also referred to as a second voltage, and a phase of the second voltage is also referred to as a second phase. The vehicle energy storage apparatus 40 connected to the first charging and discharging device 100a is also referred to as a first vehicle energy storage apparatus 40a, and another vehicle energy storage apparatus 40 connected to the second charging and discharging device 100b is also referred to as a second vehicle energy storage apparatus 40b (see FIG. 6 and the like for reference numerals, 40a and 40b).

As illustrated in FIG. 4, first, the control section 120 controls the first voltage, which is a voltage being output from the first charging and discharging device 100a that is its own charging and discharging device 100, and a first phase that is a phase of the first voltage (S102). To be specific, when the first charging and discharging device 100a is a slave machine, the control section 120 controls the first voltage being output from the first charging and discharging device 100a and the first phase in such a way as to match the second voltage that is a voltage being output from the second charging and discharging device 100b (master machine) and the second phase that is a phase of the second voltage. When the first charging and discharging device 100a is a master machine, the control section 120 controls the first voltage being output from the first charging and discharging device 100a and the first phase in such a way as to match a predetermined voltage and phase. In the present embodiment, the predetermined voltage and phase are a standard voltage (such as 202 V) and a phase of the standard voltage (such as 50 Hz or 60 Hz). As described above, the first charging and discharging device 100a includes the control section 120 that performs the voltage-type voltage control. Details of processing in which the control section 120 controls the first voltage and the first phase of the first charging and discharging device 100a will be described below.

Next, the control section 120 controls a current being output from the first charging and discharging device 100a that is the own charging and discharging device 100 (S104). To be specific, the control section 120 determines a magnitude of the current being output from the first charging and discharging device 100a according to the remaining capacity of the first vehicle energy storage apparatus 40a connected to the first charging and discharging device 100a, and performs control such that the current has the determined value. Details of processing in which the control section 120 controls the current of the first charging and discharging device 100a will be described below.

The control section 120 outputs electric power having the controlled values of the first voltage, the first phase and the current from the first charging and discharging device 100a, which is the charging and discharging device 100 itself, and supplies electric power to the electric power load 20 (S106). In short, the control section 120 controls the first voltage and the first phase of the first charging and discharging device 100a in such a way as to match the second voltage and the second phase of the second charging and discharging device 100b (master machine), and thus electric power can be supplied to all of the electric power loads 20 being the electric power loads 21 to 25. Therefore, the control section 120 supplies electric power from the first charging and discharging device 100a to all or some electric power loads 20 of the electric power loads 21 to 25. As described above, the control section 120 has a self-sustaining parallel operation function capable of performing a self-sustaining parallel operation of the charging and discharging device 100.

As described above, the processing performed by the charging and discharging system 10 (the method of controlling the charging and discharging system 10) is completed.

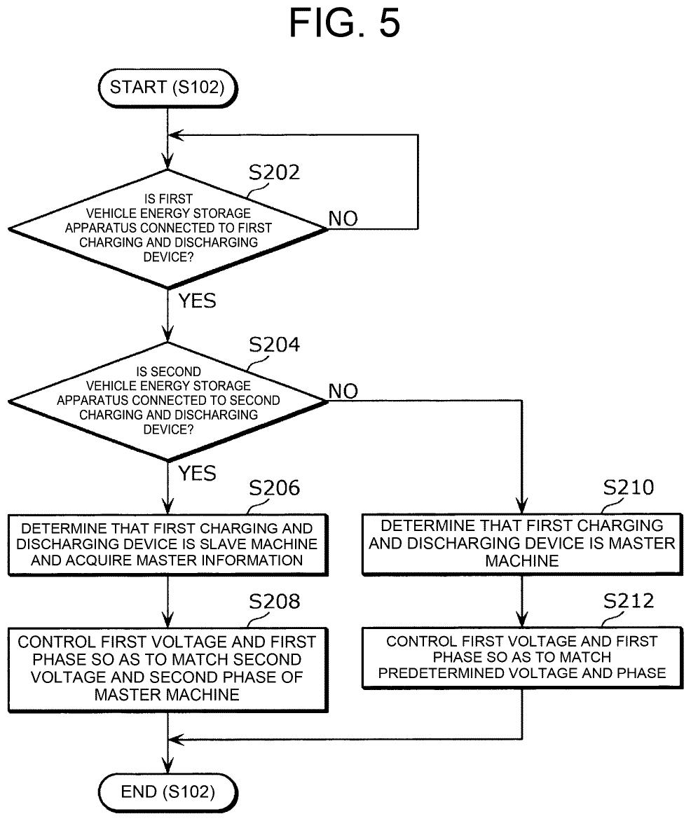

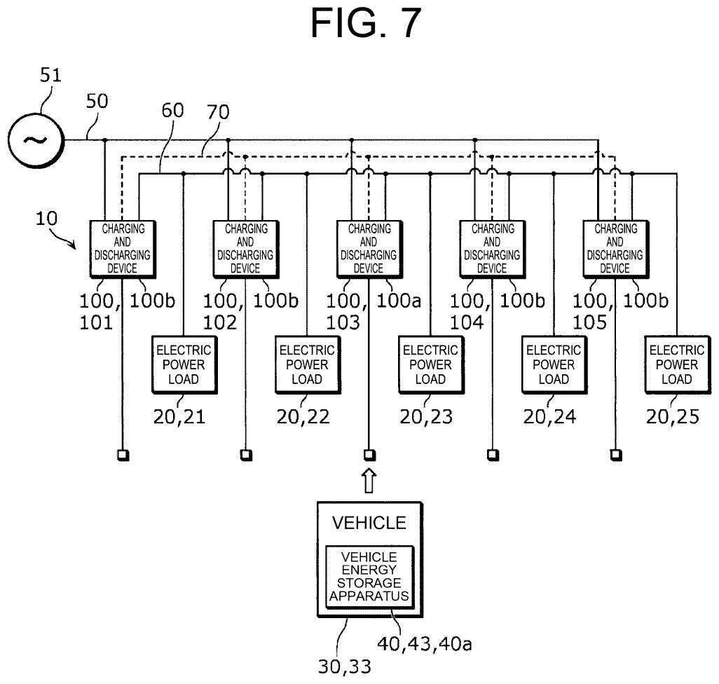

Next, processing (S102 in FIG. 4) in which the control section 120 controls the first voltage and the first phase of the first charging and discharging device 100a will be explained in detail. FIG. 5 is a flowchart illustrating processing in which the control section 120 controls the first voltage and the first phase of the first charging and discharging device 100a according to the present embodiment. FIG. 6 is a diagram for explaining processing in which the control section 120 controls the first voltage and the first phase of the first charging and discharging device 100a (when the first charging and discharging device 100a is a slave machine) according to the present embodiment. FIG. 7 is a diagram for explaining processing in which the control section 120 controls the first voltage and the first phase of the first charging and discharging device 100a (when the first charging and discharging device 100a is a master machine) according to the present embodiment.

As illustrated in FIG. 5, the control section 120 determines whether the first vehicle energy storage apparatus 40a is connected to the first charging and discharging device 100a (S202). When it is determined that the first vehicle energy storage apparatus 40a is connected to the first charging and discharging device 100a (YES in S202), the control section 120 determines whether the second vehicle energy storage apparatus 40b is connected to the second charging and discharging device 100b (S204).

In FIG. 6, the charging and discharging device 103 is a first charging and discharging device 100a, and the other charging and discharging devices 101, 102, 104, and 105 are second charging and discharging devices 100b. Further, the charging and discharging device 101 is the master machine. In this configuration, after the second vehicle energy storage apparatuses 40b (vehicle energy storage apparatuses 41 and 45) are connected to two of the second charging and discharging devices 100b (charging and discharging devices 101 and 105), the first vehicle energy storage apparatus 40a (vehicle energy storage apparatus 43) is connected to the first charging and discharging device 100a (charging and discharging device 103). In this case, the control section 120 of the first charging and discharging device 100a (charging and discharging device 103) acquires information indicating the connection from the first vehicle energy storage apparatus 40a via the charging and discharging unit 110 when the first vehicle energy storage apparatus 40a is connected to the first charging and discharging device 100a. As a result, the control section 120 determines that the first vehicle energy storage apparatus 40a has been connected to the first charging and discharging device 100a.

Returning to FIG. 5, when the control section 120 determines that the second vehicle energy storage apparatus 40b is connected to the second charging and discharging device 100b (YES in S204), the control section 120 determines that the first charging and discharging device 100a is a slave machine, and acquires master information from the second vehicle energy storage apparatus 40b being a master machine (S206). The master information is address information or the like capable of identifying the second vehicle energy storage apparatus 40b being the master machine. To be more specific, the control section 120 determines that the second charging and discharging device 100b to which the second vehicle energy storage apparatus 40b is connected first is a master machine, and the first charging and discharging device 100a to which the first vehicle energy storage apparatus 40a is connected later is a slave machine. As described above, in a case where the first vehicle energy storage apparatus 40a is connected to the first charging and discharging device 100a, if the second vehicle energy storage apparatus 40b is connected to the second charging and discharging device 100b, the control section 120 determines that the second charging and discharging device 100b is the master machine and the first charging and discharging device 100a is the slave machine. Then, the control section 120 acquires the master information from the second vehicle energy storage apparatus 40b being the master machine.

In a case where the first vehicle energy storage apparatus 40a is connected to the first charging and discharging device 100a, if the second vehicle energy storage apparatus 40b is connected to only one second charging and discharging device 100b, the control section 120 acquires the master information from the one second charging and discharging device 100b. If the second vehicle energy storage apparatus 40b is connected to each of the plurality of second charging and discharging devices 100b, the control section 120 acquires master information indicating which second charging and discharging device 100b is the master machine. In short, the control section 120 acquires master information indicating that the second vehicle energy storage apparatus 40b is a master machine from the second vehicle energy storage apparatus 40b, which is a master machine among the plurality of second charging and discharging devices 100b.

In FIG. 6, when the first vehicle energy storage apparatus 40a is connected to the first charging and discharging device 100a, the second vehicle energy storage apparatuses 40b (vehicle energy storage apparatuses 41 and 45) are connected to the plurality of second charging and discharging devices 100b (charging and discharging devices 101 and 105). Therefore, the control section 120 acquires information indicating the connection from the plurality of second charging and discharging devices 100b via the communication line 70, and determines that the second vehicle energy storage apparatus 40b is connected to the plurality of second charging and discharging devices 100b. In this case, the control section 120 determines that the first charging and discharging device 100a is a slave machine, and acquires master information indicating that the second charging and discharging device 100b (charging and discharging device 101) is a master machine from the second charging and discharging device 100b (charging and discharging device 101) being a master machine, via the communication line 70. The control section 120 writes and stores the acquired master information in the control information 141 of the storage section 140.

Returning to FIG. 5, the control section 120 controls the first voltage being output from the first charging and discharging device 100a and the first phase in such a way as to match the second voltage being output from the second charging and discharging device 100b that is the master machine indicated by the master information and the second phase (S208). To be specific, the control section 120 reads and acquires the master information from the control information 141 of the storage section 140, acquires the second voltage and the second phase from the second charging and discharging device 100b that is the master machine indicated by the master information via the communication line 70, and writes and stores the second voltage and the second phase in the control information 141 of the storage section 140. Thereafter, the control section 120 reads and acquires the second voltage and the second phase from the control information 141 of the storage section 140, and controls the first voltage and the first phase of the first charging and discharging device 100a in such a way as to match (coincide with) the second voltage and the second phase. The control section 120 may perform control for matching (coinciding) the first voltage and the first phase with the second voltage and the second phase by hardware (an analog circuit or the like) or software (a program). These hardware (an analog circuit and the like) and software (program) can be achieved by a conventionally known method.

When it is determined that second vehicle energy storage apparatus 40b is not connected to the second charging and discharging device 100b (NO in S204), the control section 120 determines that the first charging and discharging device 100a is the master machine (S210). In short, in a case where the first vehicle energy storage apparatus 40a is connected to the first charging and discharging device 100a, if the second vehicle energy storage apparatus 40b is not connected to the second charging and discharging device 100b, the control section 120 determines that the first charging and discharging device 100a is the master machine.

In FIG. 7, when the first vehicle energy storage apparatus 40a (vehicle energy storage apparatus 43) is connected to the first charging and discharging device 100a (charging and discharging 103), the second vehicle energy storage apparatus 40b is not connected to any of the second charging and discharging devices 100b. In this case, the control section 120 of the first charging and discharging device 100a (charging and discharging device 103) determines that the first charging and discharging device 100a is the master machine because the master information is not acquired from any of the second charging and discharging devices 100b when the first vehicle energy storage apparatus 40a is connected to the first charging and discharging device 100a. Thus, the control section 120 generates master information indicating that the first charging and discharging device 100a is a master machine, and writes and stores the master information in the control information 141 of the storage section 140. Further, the control section 120 transmits master information indicating that the first charging and discharging device 100a is a master machine to the second charging and discharging device 100b via the communication line 70.

Returning to FIG. 5, the control section 120 controls the first voltage being output from the first charging and discharging device 100a and the first phase in such a way as to match a predetermined voltage and phase (S212). To be specific, the control section 120 reads and acquires a preset standard voltage and a phase thereof from the control information 141 of the storage section 140, and controls the first voltage and the first phase of the first charging and discharging device 100a in such a way as to match (coincide with) the standard voltage and the phase thereof. The control section 120 may perform control for matching (coinciding) the first voltage and the first phase with the standard voltage and the phase thereof by hardware (an analog circuit or the like) or software (a program). These hardware (an analog circuit and the like) and software (program) can be achieved by a conventionally known method.

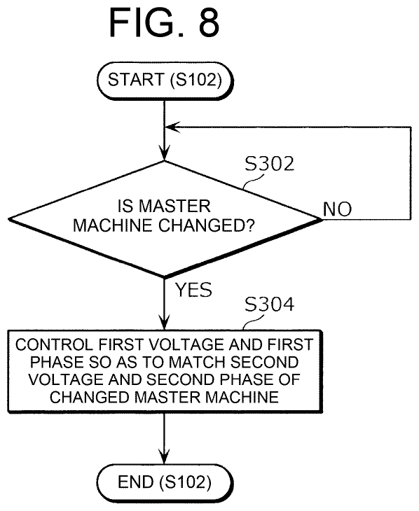

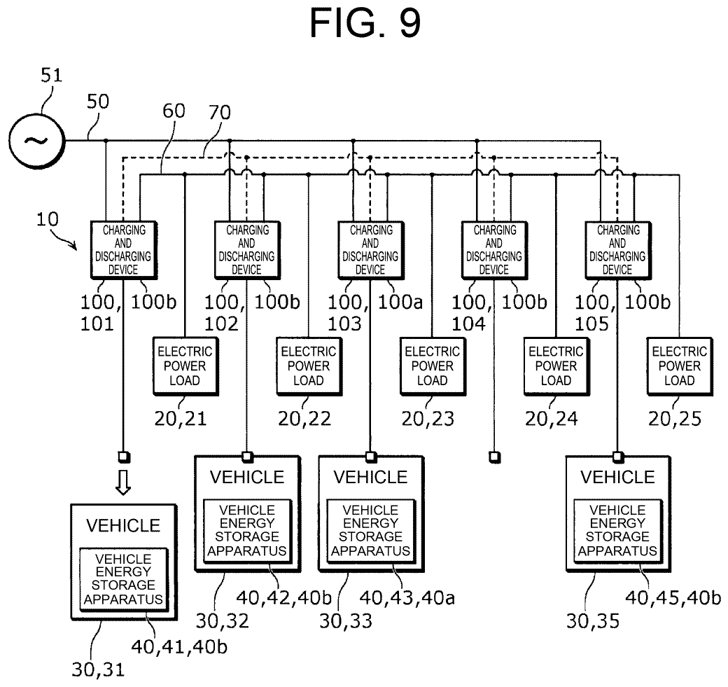

Next, in the processing (S102 in FIG. 4) in which the control section 120 controls the first voltage and the first phase of the first charging and discharging device 100a, processing in a case where the master machine is changed will be explained in detail. FIG. 8 is a flowchart illustrating processing in which the control section 120 controls the first voltage and the first phase of the first charging and discharging device 100a (when the master machine is changed) according to the present embodiment. FIG. 9 is a diagram for explaining processing in which the control section 120 controls the first voltage and the first phase of the first charging and discharging device 100a (when the master machine is changed) according to the present embodiment.

As illustrated in FIG. 8, the control section 120 determines whether the master machine has been changed (S302). When it is determined that the master machine has been changed (YES in S302), the control section 120 controls the first voltage and the first phase of the first charging and discharging device 100a in such a way as to match the second voltage and the second phase of the second charging and discharging device 100b being the changed master machine. To be specific, the control section 120 determines that the master machine has been changed when the value indicating the remaining capacity of the second vehicle energy storage apparatus 40b connected to the second charging and discharging device 100b being the master machine becomes equal to or less than a predetermined threshold value, or when the second vehicle energy storage apparatus 40b is disconnected from the second charging and discharging device 100b being the master machine.

FIG. 9 illustrates a state in which the vehicle energy storage apparatus 41 (second vehicle energy storage apparatus 40b) is disconnected from the charging and discharging device 101 (second charging and discharging device 100b) that is the master machine. In this case, the control section 120 of the first charging and discharging device 100a (charging and discharging device 103) acquires information indicating that the vehicle energy storage apparatus 41 (second vehicle energy storage apparatus 40b) has been disconnected from the charging and discharging device 101 (second charging and discharging device 100b) via the communication line 70. As a result, the control section 120 determines that the master machine has been changed. In the present embodiment, when the vehicle energy storage apparatus 41 is disconnected, the charging and discharging device 101 transfers the master authority to the charging and discharging device 102. As a result, the charging and discharging device 102 becomes the master machine, and the control section 120 of the first charging and discharging device 100a (charging and discharging device 103) acquires master information indicating that the charging and discharging device 102 is the master machine from the charging and discharging device 102 via the communication line 70. The control section 120 writes the acquired master information in the control information 141 of the storage section 140 and updates the control information 141.

The control section 120 then reads and acquires the master information from the control information 141 of the storage section 140. The control section 120 acquires the second voltage and the second phase from the second charging and discharging device 100b (charging and discharging device 102) that is the master machine indicated by the master information via the communication line 70, and then writes and stores the second voltage and the second phase in the control information 141 of the storage section 140. Thereafter, the control section 120 reads and acquires the second voltage and the second phase from the control information 141 of the storage section 140, and controls the first voltage and the first phase of the first charging and discharging device 100a in such a way as to match (coincide with) the second voltage and the second phase. When the charging and discharging device 101 transfers the master authority to the charging and discharging device 103 (first charging and discharging device 100a), the control section 120 performs similar processing to the processing (S210 to S212 in FIG. 5) when it is determined that the first charging and discharging device 100a is a master machine.

Even when the value indicating a remaining capacity of the vehicle energy storage apparatus 41 (vehicle energy storage device 40b) connected to the charging and discharging device 101 (second charging and discharging device 100b) being a master machine becomes equal to or less than a predetermined threshold value, the charging and discharging device 101 transfers master authority to the charging and discharging device 102. Also in this case, the control section 120 of the first charging and discharging device 100a (charging and discharging device 103) acquires information indicating that the master authority has been transferred to the charging and discharging device 102 from the charging and discharging device 101 or the charging and discharging device 102 via the communication line 70, and determines that the master machine has been changed.

The remaining capacity of the second vehicle energy storage apparatus 40b is an electric capacity charged in the second vehicle energy storage apparatus 40b. The predetermined threshold value is a threshold value for comparison with a magnitude of the remaining capacity of the second vehicle energy storage apparatus 40b. Since a SOC or a voltage value can be used as an index indicating the remaining capacity of the second vehicle energy storage apparatus 40b, in the present embodiment, the predetermined threshold value is a threshold value (% or V) for comparison with the magnitude of the SOC or the voltage value of the second vehicle energy storage apparatus 40b. The second charging and discharging device 100b (charging and discharging device 101) determines whether the value indicating the remaining capacity of the second vehicle energy storage apparatus 40b is equal to or less than the predetermined threshold value.

As described above, the processing (S102 in FIG. 4) in which the control section 120 controls the first voltage and the first phase of the first charging and discharging device 100a is completed.

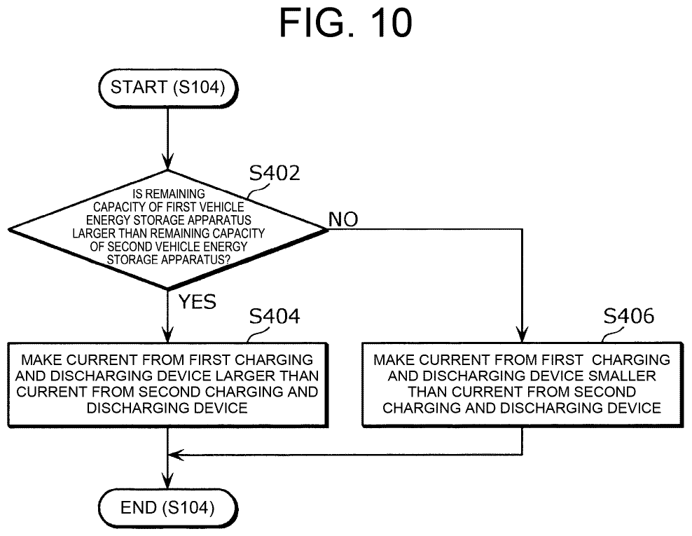

Next, processing in which the control section 120 controls a current of the first charging and discharging device 100a (S104 in FIG. 4) will be explained in detail. FIG. 10 is a flowchart illustrating processing in which the control section 120 controls the current of the first charging and discharging device 100a according to the present embodiment.

As illustrated in FIG. 10, the control section 120 determines whether the remaining capacity of the first vehicle energy storage apparatus 40a connected to the first charging and discharging device 100a is larger than the remaining capacity of the second vehicle energy storage apparatus 40b connected to the second charging and discharging device 100b (S402).

Similarly to the remaining capacity of the second vehicle energy storage apparatus 40b described above, the remaining capacity of the first vehicle energy storage apparatus 40a is an electric capacity charged in the first vehicle energy storage apparatus 40a, and an SOC or a voltage value can be used as an index indicating the remaining capacity of the first vehicle energy storage apparatus 40a. In short, the control section 120 can compare the remaining capacities by comparing the SOCs or voltage values of the first vehicle energy storage apparatus 40a and the second vehicle energy storage apparatus 40b. To be specific, the control section 120 acquires a value (SOC, voltage value, or the like) indicating the remaining capacity of the second vehicle energy storage apparatus 40b from the second charging and discharging device 100b via the communication line 70, and compares the value with a value (SOC, voltage value, or the like) indicating the remaining capacity of the first vehicle energy storage apparatus 40a, thereby comparing the remaining capacities.

When it is determined that the remaining capacity of the first vehicle energy storage apparatus 40a is larger than the remaining capacity of the second vehicle energy storage apparatus 40b (YES in S402), the control section 120 controls a current of electric power being output from the first charging and discharging device 100a in such a way as to be larger than a current of electric power being output from the second charging and discharging device 100b (S404). When it is determined that the remaining capacity of the first vehicle energy storage apparatus 40a is smaller than the remaining capacity of the second vehicle energy storage apparatus 40b (NO in S402), the control section 120 controls the current of the electric power being output from the first charging and discharging device 100a in such a way as to be smaller than the current of the electric power being output from the second charging and discharging device 100b (S406). When it is determined that the remaining capacity of the first vehicle energy storage apparatus 40a is the same as the remaining capacity of the second vehicle energy storage apparatus 40b, the control section 120 controls the current of the electric power being output from the first charging and discharging device 100a in such a way as to have the same value as the current of the electric power being output from the second charging and discharging device 100b. The control section 120 may control the current of the first charging and discharging device 100a by hardware (an analog circuit or the like) or by software (program). These hardware (an analog circuit and the like) and software (program) can be achieved by a conventionally known method.

As described above, the control section 120 determines the magnitude of the current being output from the first charging and discharging device 100a according to the remaining capacity of the first vehicle energy storage apparatus 40a connected to the first charging and discharging device 100a. To be more specific, the control section 120 compares the remaining capacity of the first vehicle energy storage apparatus 40a with the remaining capacity of the second vehicle energy storage apparatus 40b connected to the second charging and discharging device 100b, and sets the current being output from the charging and discharging device 100 connected to the vehicle energy storage apparatus 40 having a large remaining capacity to be larger than the current being output from the charging and discharging device 100 connected to the vehicle energy storage apparatus 40 having a small remaining capacity.

As described above, the processing (S104 in FIG. 4) in which the control section 120 controls the current of the first charging and discharging device 100a is completed.

An example of operations to be performed when the charging and discharging device 100 having the above-described self-sustaining parallel function performs the self-sustaining parallel operation will be explained below. In the self-sustaining parallel operation, parallel output is performed in a master/slave operation, based on a signal from a master machine. Each charging and discharging device 100 is provided with an address, a charging and discharging device 100 with an address 1 is set as a master machine, and charging and discharging devices 100 with an address 2 or later are set as slave machines. The self-sustaining parallel operation sequence is as follows.

(1) When the master machine detects a power failure, the master machine confirms states of all the slave machines in the charging and discharging system 10 by RS485 communication or the like via the communication line 70. (2) If all the slave machines are normal, the master machine instructs the slave machines to transmit power and starts parallel operation. All the slave machines being normal indicates a state in which there is no occurrence of abnormality and communication abnormality in all of the charging and discharging devices 100. (3) The master machine confirms the state of the slave machine for 5 seconds, excludes a device whose abnormality (including no response) is not cancelled within 5 seconds from parallel operation, and starts the parallel operation by using the remaining charging and discharging devices 100. (4) If the normality of the abnormal device can be confirmed after the parallel operation, the master machine is added to the parallel operation. (5) The master machine constantly monitors a communication and self-sustaining synchronous signals between the charging and discharging devices 100 even when the electric power system 50 is normal, and outputs a communication abnormality at the time of abnormality.

As for the setting of the master authority, when the electric power system 50 is normal, the charging and discharging device 100 (the charging and discharging device 101 or the like) with the address 1 becomes the master machine, and the charging and discharging devices 100 with other addresses become the slave machines. At the time of power failure of the electric power system 50, the charging and discharging device 100 with the address 1 confirms the communication state between the devices as a master machine, and recognizes the other device with which communication is being performed as a slave machine. When the master machine is stopped by abnormality and a stop command, the master authority is transferred to the slave machine with the next address. When the slave machine is abnormal at the time of transfer, the authority is transferred to slave machines with addresses one after another. When the master machine has the lowest address, the authority is transferred to the highest address (address 1). At the time of transferring the master authority, when the authority cannot be transferred due to the abnormality of all the slave machines, master authority transfer abnormality is output. When the control power supply of the master machine is stopped before the master authority transfer, the master machine does not exist in the charging and discharging system 10, and thus the self-sustaining operation is stopped.

### [4 Explanation of Effects]

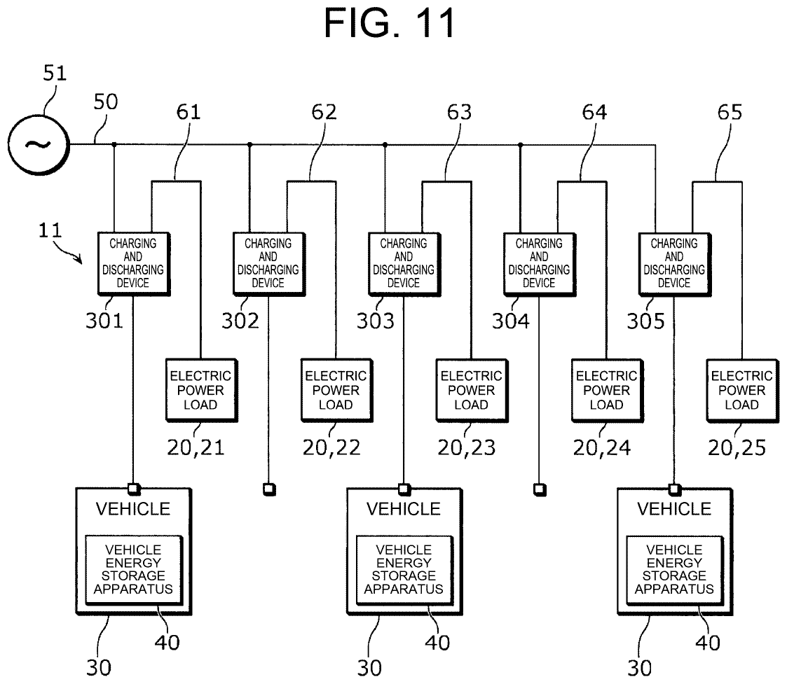

In a conventional charging and discharging system, electric power cannot be supplied from one charging and discharging device to an electric power load connected to another charging and discharging device. FIG. 11 is a block diagram illustrating a configuration of a conventional charging and discharging system 11. FIG. 11 is a diagram corresponding to the block diagram of the charging and discharging system 10 in the present embodiment illustrated in FIG. 2. As illustrated in FIG. 11, in the conventional charging and discharging system 11, a charging and discharging device 301 is connected to an electric power load 21 via an electric wire 61, and is configured to be able to supply electric power to the electric power load 21. However, since the charging and discharging device 301 is not connected to electric wires 62 to 65, electric power cannot be supplied to electric power loads 22 to 25 via the electric wires 62 to 65. In short, in the conventional charging and discharging system 11, electric power cannot be supplied from one charging and discharging device 301 to the electric power loads 22 to 25 connected to other charging and discharging devices 302 to 305. The same applies to the charging and discharging devices 302 to 305. Therefore, at the time of power failure or the like, electric power cannot be supplied to the electric power loads 22 and 24 from the charging and discharging devices 302 and 304 to which the vehicle energy storage apparatus 40 is not connected, and the supply of electric power to the electric power loads 22 and 24 is stopped. In contrast, the charging and discharging system 10 according to the present embodiment can supply electric power from one charging and discharging device 100 to the electric power load 20 connected to another charging and discharging device 100. This will be explained in detail below.

As illustrated in FIG. 6, the charging and discharging system 10 according to the present embodiment controls the first voltage being output from the first charging and discharging device 100a to which the first vehicle energy storage apparatus 40a is connected, and the first phase in such a way as to match the second voltage being output from the second charging and discharging device 100b to which the second vehicle energy storage apparatus 40b is connected and the second phase. In this way, the first voltage being output from the first charging and discharging device 100a and the first phase are matched with the second voltage being output from the second charging and discharging device 100b and the second phase, the first charging and discharging device 100a and the second charging and discharging device 100b can be connected in parallel. In short, the first charging and discharging device 100a has a self-sustaining parallel function. Thus, electric power can be supplied from the first charging and discharging device 100a to the electric power load 20 connected to the second charging and discharging device 100b, and electric power can be supplied from the second charging and discharging device 100b to the electric power load 20 connected to the first charging and discharging device 100a. Therefore, according to the charging and discharging system 10, electric power can be supplied from one of the charging and discharging devices 100 to which the vehicle energy storage apparatus 40 of the vehicle 30 is connected, to the electric power load 20 connected to another of the charging and discharging devices 100. When the vehicle 30 is parked in one of a plurality of parking spaces, electric power can be supplied from the vehicle energy storage apparatus 40 not only to the electric power load 20 connected to the charging and discharging device 100 provided in the parking space but also to the electric power load 20 connected to the charging and discharging device 100 provided in another parking space. Power can be supplied from the vehicle energy storage apparatus 40 to the electric power load 20 without a driver of the vehicle 30 having to worry about which parking space to park in.

It is assumed that the electric wires 61 to 65 are connected in the conventional charging and discharging system 11 illustrated in FIG. 11. The conventional charging and discharging system 11 uses a voltage-type current-controlled charging and discharging device (current-type inverter), and when the charging and discharging device of the voltage source fails, electric power cannot be supplied. In contrast, in the charging and discharging system 10 according to the present embodiment, the voltage-type voltage-controlled charging and discharging devices perform the self-sustaining parallel operation. The charging and discharging system 10 is particularly useful from the viewpoint of Business Continuity Plan (BCP) because the charging and discharging system 10 can continue to supply electric power even if any one of the charging and discharging devices fails.

The charging and discharging system 10 sets the second charging and discharging device 100b to which the vehicle energy storage apparatus 40 is connected first as a master machine, sets the first charging and discharging device 100a to which the vehicle energy storage apparatus 40 is connected later as a slave machine, and controls the first voltage and the first phase of the slave machine in such a way as to match the second voltage and the second phase of the master machine. The charging and discharging system 10 sets the master machine and the slave machine in this way, and connects the master machine and the slave machine in parallel. Thus, electric power can be supplied from the slave machine to the electric power load 20 connected to the master machine, and electric power can be supplied from the master machine to the electric power load 20 connected to the slave machine.

The charging and discharging system 10 acquires master information indicating which of the second charging and discharging devices 100b is a master machine, and controls the first voltage and the first phase in such a way as to match the second voltage and the second phase of the second charging and discharging device 100b that is the master machine indicated by the master information. As described above, the charging and discharging system 10 sets the master machine from the master information, and connects the master machine and the slave machine in parallel. Thus, electric power can be supplied from the slave machine to the electric power load 20 connected to the master machine, and electric power can be supplied from the master machine to the electric power load 20 connected to the slave machine.

The charging and discharging system 10 sets the first charging and discharging device 100a to which the vehicle energy storage apparatus 40 is first connected as a master machine, and controls the first voltage and the first phase of the master machine in such a way as to match a predetermined voltage and phase. In other words, when there is no other charging and discharging device 100 for which the voltage and the phase are to be matched, the charging and discharging device 100 itself is determined to be the master machine, and controls the first voltage and the first phase in such a way as to match a predetermined voltage and phase. Thus, the charging and discharging system 10 can set the voltage and the phase of the slave machine to which the vehicle energy storage apparatus 40 is connected later, based on the voltage and the phase of the master machine, and the master machine and the slave machine can be connected in parallel.

Even when the master machine has been changed, the charging and discharging system 10 controls the first voltage and first phase of the slave machine in such a way as to match the second voltage and second phase of the changed master machine, thereby enabling to connect the changed master machine and the slave machine in parallel.

When a value indicating a remaining capacity of the second vehicle energy storage apparatus 40b connected to the second charging and discharging device 100b being the master machine becomes equal to or less than a predetermined threshold value, or when the second vehicle energy storage apparatus 40b is disconnected from the second charging and discharging device 100b being the master machine, electric power cannot be supplied from the second charging and discharging device 100b. Therefore, it is necessary to change the master machine. Therefore, the charging and discharging system 10 changes the master machine when the value indicating the remaining capacity of the second vehicle energy storage apparatus 40b connected to the second charging and discharging device 100b being the master machine becomes equal to or less than a predetermined threshold value, or when the second vehicle energy storage apparatus 40b is disconnected from the second charging and discharging device 100b being the master machine. Thus, the charging and discharging system 10 can connect the changed master machine and the slave machine in parallel by controlling the first voltage and the first phase of the slave machine in such a way as to match the second voltage and the second phase of the changed master machine.

When the remaining capacity of the first vehicle energy storage apparatus 40a connected to the first charging and discharging device 100a changes, electric power that can be discharged from the first vehicle energy storage apparatus 40a changes, and electric power that can be supplied from the first charging and discharging device 100a to the electric power load 20 changes in some cases. Therefore, the charging and discharging system 10 determines a magnitude of the current being output from the first charging and discharging device 100a according to the remaining capacity of the first vehicle energy storage apparatus 40a connected to the first charging and discharging device 100a. Thus, the charging and discharging system 10 can supply electric power of a magnitude corresponding to the remaining capacity of the first vehicle energy storage apparatus 40a from the first charging and discharging device 100a to the electric power load 20.

As the remaining capacity of the vehicle energy storage apparatus 40 connected to the charging and discharging device 100 is larger, a larger amount of electric power can be discharged from the vehicle energy storage apparatus 40, and thus a larger amount of electric power can be supplied from the charging and discharging device 100 to the electric power load 20. Therefore, the charging and discharging system 10 compares the remaining capacities of the first vehicle energy storage apparatus 40a and the second vehicle energy storage apparatus 40b, and increases the current being output from the charging and discharging device 100 connected to the vehicle energy storage apparatus 40 having the larger remaining capacity. Thus, the charging and discharging system 10 can supply electric power from the charging and discharging device 100 to the electric power load 20 in a well-balanced manner.

In the charging and discharging system 10, the first charging and discharging device 100a to which the first vehicle energy storage apparatus 40a is connected performs voltage-type voltage control. In this way, since the first charging and discharging device 100a performs the voltage-type voltage control, the first charging and discharging device 100a and the second charging and discharging device 100b that is another charging and discharging device 100 can be connected in parallel. In short, the charging and discharging system 10 has a self-sustaining parallel function. Thus, electric power can be supplied from the first charging and discharging device 100a to the electric power load 20 connected to the second charging and discharging device 100b, and electric power can be supplied from the second charging and discharging device 100b to the electric power load 20 connected to the first charging and discharging device 100a. Therefore, according to the charging and discharging system 10, electric power can be supplied from one charging and discharging device 100 to the electric power load 20 connected to another charging and discharging device 100, among the charging and discharging devices 100 to which the vehicle energy storage apparatus 40, being an energy storage apparatus of the vehicle 30, is connected.

In the method of controlling the charging and discharging system 10 according to the present embodiment, the first voltage being output from the first charging and discharging device 100a to which the first vehicle energy storage apparatus 40a is connected and the first phase are controlled in such a way as to match the second voltage being output from the second charging and discharging device 100b to which the second vehicle energy storage apparatus 40b is connected and the second phase. Thus, as described above, electric power can be supplied from the first charging and discharging device 100a to the electric power load 20 connected to the second charging and discharging device 100b, and electric power can be supplied from the second charging and discharging device 100b to the electric power load 20 connected to the first charging and discharging device 100a. Therefore, according to the method of controlling the charging and discharging system 10, it is possible to supply electric power from one charging and discharging device 100 to the electric power load 20 connected to another charging and discharging device 100, among the charging and discharging devices 100 to which the vehicle energy storage apparatus 40, being an energy storage apparatus of the vehicle 30, is connected.

### [5 Explanation of Modifications]

Although the charging and discharging system 10 and the control method thereof according to the present embodiment have been explained above, the present invention is not limited to the above-described embodiment. These disclosed embodiments are described by way of example only in every respect, but not restrictive, and the scope of the present invention includes all modifications within the meaning and scope equivalent to the scope of the claims.

In the above-described embodiment, it is assumed that the charging and discharging system 10 includes a plurality of the charging and discharging devices 100, but only one charging and discharging device 100 may be included. In short, in the above embodiment, the charging and discharging system 10 may include only one charging and discharging device 100, and the voltage and phase of the charging and discharging device 100 may be controlled in such a way as to match the voltage and phase of a charging and discharging device included in another charging and discharging system.

In the above-described embodiment, the charging and discharging system 10 may further include a power conditioner. In this case, the charging and discharging device 100 (first charging and discharging device 100a) may be switched in such a way as to perform voltage-type current control when the power conditioner is operating, and to perform voltage-type voltage control when the power conditioner is stopped. Thus, the charging and discharging device 100 (first charging and discharging device 100a) can supply electric power to the electric power load 20 and the like even when the power conditioner is stopped. In this case, the processing section in the power conditioner may have the function of the control section 120 of the charging and discharging device 100. The charging and discharging device 100 may be integrated with the power conditioner. The function of the charging and discharging device 100 may be incorporated in the power conditioner, or the function of the power conditioner may be incorporated in the charging and discharging device 100.

When the power conditioner is used in the charging and discharging system 10, it is preferable to use a power conditioner with a storage battery (for example, a solar power conditioner with a storage battery) which can be a stable voltage source. Securing a stable voltage source leads to enhancement of BCP, and improvement of local disaster prevention/disaster reduction and resilience functions.

In the above-described embodiment, the communication section 130 may have a function of the control section 120, or a device in another charging and discharging device 100 may have the function. The control section 120 may also have a function of controlling the voltage being output from another slave machine and the phase thereof in such a way as to match the voltage being output from the master machine and the phase thereof.

In the above-described embodiment, it is assumed that the charging and discharging device 100 includes the storage section 140. However, the charging and discharging device 100 may not include the storage section 140, and may store information in an external recording medium and acquire information from the recording medium.

In the above-described embodiment, it has been assumed that the control section 120 of the charging and discharging device 100 determines the magnitude of the current being output from the charging and discharging device 100 according to the remaining capacity of the vehicle energy storage apparatus 40 connected to the charging and discharging device 100, but the present invention is not limited to this. The control section 120 may determine the magnitude of the current, based on an index other than the remaining capacity, or may perform control such that currents being output from all of the charging and discharging devices 100 included in the charging and discharging system 10 have the same magnitude regardless of the remaining capacity or the like.

In the above-described embodiment, it has been assumed that the vehicle energy storage apparatus 40 is an energy storage apparatus (battery) that is mounted on the vehicle 30 such as an EV, supplies electric power to the vehicle 30, and drives the vehicle 30, but the vehicle energy storage apparatus 40 is not limited thereto. The vehicle energy storage apparatus 40 may be an energy storage apparatus (a battery or the like loaded in a container) carried by the vehicle 30 such as a gasoline vehicle.

The present invention can be achieved not only as the charging and discharging system 10 and the method of controlling the charging and discharging system 10, but also as a program for causing a computer to execute the processing included in the method of controlling the charging and discharging system 10. In short, each component included in the charging and discharging device 100 of the charging and discharging system 10 may be achieved by a program execution section, such as a CPU or a processor, reading and executing a software program recorded in a recording medium such as a hard disk or a semiconductor memory. The present invention can also be achieved as a computer-readable non-transitory recording medium in which the program is recorded, for example, a flexible disk, a hard disk, a CD-ROM, an MO, a DVD, a DVD-ROM, a DVD-RAM, a Blu-ray (R) Disc (BD), or a semiconductor memory. The program can be distributed via the recording medium and a transmission medium such as the Internet. The present invention can also be achieved as an integrated circuit including the processing section included in the charging and discharging device 100. In short, each functional block of the charging and discharging device 100 illustrated in FIG. 3 may be achieved as a large scale integration (LSI) which is an integrated circuit. These may be individually formed into one chip, or may be formed into one chip in such a way as to include a part or all of them. As described above, each component of the charging and discharging device 100 may be configured by dedicated hardware, or may be achieved by executing a software program suitable for each component.

Modes constructed by combining arbitrary components in the above-described embodiment and modifications thereof are also included in the scope of the present invention.

The present invention is applicable to a charging and discharging system to which an energy storage apparatus of a vehicle is connected, or the like.

1. A charging and discharging system including a charging and discharging device to which a vehicle energy storage apparatus being an energy storage apparatus of a vehicle is connected, the charging and discharging device supplying electric power to an electric power load,
the charging and discharging system comprising: a first charging and discharging device that is the charging and discharging device to which a first vehicle energy storage apparatus being the vehicle energy storage apparatus is connected and that is electrically connected to a second charging and discharging device being another charging and discharging device to which a second vehicle energy storage apparatus being another vehicle energy storage apparatus is connected,
wherein the first charging and discharging device includes a control section that controls a first voltage that is a voltage being output from the first charging and discharging device, and a first phase that is a phase of the first voltage in such a way as to match a second voltage that is a voltage being output from the second charging and discharging device, and a second phase that is a phase of the second voltage.

2. The charging and discharging system according to claim 1,
wherein, in a case where the first vehicle energy storage apparatus is connected to the first charging and discharging device, if the second vehicle energy storage apparatus is connected to the second charging and discharging device, the control section determines that the second charging and discharging device is a master machine and the first charging and discharging device is a slave machine, and controls the first voltage and the first phase in such a way as to match the second voltage and the second phase of the second charging and discharging device.

3. The charging and discharging system according to claim 2,
wherein, if the second vehicle energy storage apparatus is connected to each of the plurality of second charging and discharging devices, the control section acquires master information indicating which of the second charging and discharging devices is a master machine, and controls the first voltage and the first phase in such a way as to match the second voltage and the second phase of the second charging and discharging device being the master machine indicated by the master information.

4. The charging and discharging system according to claim 1,
wherein, in a case where the first vehicle energy storage apparatus is connected to the first charging and discharging device, if the second vehicle energy storage apparatus is not connected to the second charging and discharging device, the control section determines that the first charging and discharging device is a master machine, and controls the first voltage and the first phase in such a way as to match a predetermined voltage and phase.

5. The charging and discharging system according to claim 1,
wherein, when it is determined that a master machine is changed, the control section controls the first voltage and the first phase in such a way as to match the second voltage and the second phase of the second charging and discharging device being the changed master machine.

6. The charging and discharging system according to claim 5,
wherein the control section determines that the master machine is changed when a value indicating a remaining capacity of the second vehicle energy storage apparatus connected to the second charging and discharging device being the master machine becomes equal to or less than a predetermined threshold value or when the second vehicle energy storage apparatus is disconnected from the second charging and discharging device being the master machine.

7. The charging and discharging system according to claim 1,
wherein the control section determines a magnitude of a current being output from the first charging and discharging device according to a remaining capacity of the first vehicle energy storage apparatus connected to the first charging and discharging device.

8. The charging and discharging system according to claim 7,
wherein the control section compares the remaining capacity of the first vehicle energy storage apparatus with a remaining capacity of the second vehicle energy storage apparatus connected to the second charging and discharging device, and sets a current being output from the charging and discharging device connected to the vehicle energy storage apparatus having a larger remaining capacity to be larger than a current being output from the charging and discharging device connected to the vehicle energy storage apparatus having a smaller remaining capacity.

9. A charging and discharging system
including a charging and discharging device to which a vehicle energy storage apparatus being an energy storage apparatus of a vehicle is connected, the charging and discharging device supplying electric power to an electric power load,
the charging and discharging system comprising a first charging and discharging device that is the charging and discharging device to which a first vehicle energy storage apparatus being the vehicle energy storage apparatus is connected,
wherein the first charging and discharging device includes a control section that performs voltage-type voltage control.

10. A method of controlling a charging and discharging system including a charging and discharging device to which a vehicle energy storage apparatus being an energy storage apparatus of a vehicle is connected, the charging and discharging device supplying electric power to an electric power load,
the method comprising,
by a first charging and discharging device that is the charging and discharging device to which a first vehicle energy storage apparatus being the vehicle energy storage apparatus is connected and that is electrically connected to a second charging and discharging device being another charging and discharging device to which a second vehicle energy storage apparatus being another vehicle energy storage apparatus is connected,
controlling a first voltage that is a voltage being output from the first charging and discharging device, and a first phase that is a phase of the first voltage in such a way as to match a second voltage that is a voltage being output from the second charging and discharging device, and a second phase that is a phase of the second voltage.

11. A program for causing a computer to execute processing included in the method of controlling the charging and discharging system according to claim 10.
